(19) United States
(12) Patent Application Publication
(10) Pub. No.: US 2014/0114007 A1
(43) Pub. Date: Apr. 24, 2014

(54) TEMPORARY FIXING COMPOSITION

(71) Applicants: Yasutoshi Nogami, Tokyo (JP); Manabu Kirino, Tokyo (JP); Yoshimune Shundoh, Tokyo (JP); Shinya Kodaira, Tokyo (JP)

(72) Inventors: Yasutoshi Nogami, Tokyo (JP); Manabu Kirino, Tokyo (JP); Yoshimune Shundoh, Tokyo (JP); Shinya Kodaira, Tokyo (JP)

(73) Assignee: THREE BOND CO., LTD., Tokyo (JP)

(21) Appl. No.: 14/127,641

(22) PCT Filed: Jun. 18, 2012
(86) PCT No.: PCT/JP2012/065522

§ 371 Date: Dec. 19, 2013

(30) Foreign Application Priority Data
Jun. 20, 2011 (JP) 2011-136018

(51) Int. Cl. C08L 45/00; C08L 23/02

(52) U.S. Cl. CPC C08L 45/00; C08L 23/02
USPC 524/487

(57) ABSTRACT

The present invention provides a temporary fixing composition capable of fixing wafers and the like and metals with high adhesive strength and removing easily and completely the wafers and the like and the metals without breakage thereof. The temporary fixing composition used for flat surface polishing includes the following components (A) to (C): Component (A): a thermoplastic resin polymerized from an α-olefin having 16 to 35 carbon atoms alone; Component (B): a hydrogenated tackifier; and Component (C): a hydrocarbon compound which is in the state of a solid at 25° C., and having a melt viscosity of 1 to 5000 mPa·s at 100° C. and a Shore D hardness of 30 to 100.

### TECHNICAL FIELD

The present invention relates to a non-reactive temporary fixing composition which is suitable for firm temporary fixation of an adherend.

### BACKGROUND ART

In usual, materials excluding metals such as silicon wafers, sapphire glass, ceramic materials, optical glass, crystal, and magnetic materials (hereinafter which may sometimes be referred to as “wafers and the like”) and metals are subjected to a surface processing, and then they are used. The surface processing of the wafers and the like may include flat surface polishing, and the surface processing of the metals may include grinding. The surface processing is performed after the wafers and the like and the metals are temporarily fixed once using a temporary fixing composition. When the temporary fixation is performed, the surface processing can be performed efficiently, because the wafers and the like and the metals can be fixed against a force in a shear direction.

Various temporary fixing compositions have hitherto been known. For example, they may be exemplified by a hot melt-type resin in the state of a solid at room temperature. The hot melt-type resin is a so-called non-reactive temporary fixing composition, which temporarily fixes the wafers and the like and the melts by heating the resin, applying the molten resin thereon and drying it. The conventional non-reactive temporary fixing compositions, however, have low strength and hardness, and thus they cannot fix sufficiently the wafers and the like and the metals. In addition, because according to the conventional non-reactive temporary fixing compositions, the temporarily fixation is performed by application of the molten resin, a uniform coating film cannot be formed due to the surface tension and the like, when the wafers and the like and the metals have a large area. Furthermore, the molten resin may sometimes have a temperature of 100° C. or higher, and thus materials to which the resin can be applied are limited. Washing with an alkali solvent or a halogen organic solvent is necessary for removing the temporary fixing composition from the wafers and the like and the metals after the surface processing, and thus the resin has also problems in terms of the workability.

In view of the problems described above, Patent Literature 1 describes a temporary fixing composition including a resin composition curable with active energy rays (a so-called a “reactive temporary fixing composition”). The publication describes that according to Patent Literature 1, the temporary fixing composition has a high adhesive strength and a good releasability in hot water.

### CITATION LIST

### Patent Literatures

Patent Literature 1: JP-A-2006-290957

### SUMMARY OF INVENTION

### Technical Problem

It is revealed that the reactive temporary fixing composition described in Patent Literature 1, however, causes cure shrinkage when it is cured, and the wafers and the like and the metals may sometimes partially deformed. It is also revealed that when the temporary fixing composition has a high adhesive strength, wafers and the like and the metals can be firmly fixed, which may sometimes cause incomplete release from the wafers and the like and the metals with damage thereof.

### Solution to Problem

In order to attain the objects described above, the present inventors have done painstaking investigation; as a result, they have found that a temporary fixing composition including a predetermined thermoplastic resin, a predetermined tackifier, and a predetermined hydrocarbon compound can solve the problems described above, and have completed the present invention.

The gist of the present invention will be explained below.

A first aspect of the present invention is a temporary fixing composition used for flat surface polishing which includes the following components (A) to (C):

Component (A): a thermoplastic resin polymerized from an α-olefin having 16 to 35 carbon atoms alone;

Component (B): a hydrogenated tackifier; and

Component (C): a hydrocarbon compound which is in the state of a solid at 25° C., and

having a melt viscosity of 1 to 5000 mPa·s at 100° C. and a Shore D hardness of 30 to 100.

A second aspect of the present invention is a temporary fixing composition used for metal grinding, which includes the following components (A) to (C):

Component (A): a thermoplastic resin polymerized from an α-olefin having 16 to 35 carbon atoms alone;

Component (B): a hydrogenated tackifier; and

Component (C): a hydrocarbon compound which is in the state of a solid at 25° C., and

having a melt viscosity of 1000 to 20000 mPa·s at 100° C. and a Shore D hardness of 20 to 50.

A third aspect of the present invention is the temporary fixing composition according to the first or second aspect, which does not substantially includes a hydrocarbon compound which is in the state of liquid at 25° C.

A fourth aspect of the present invention is the temporary fixing composition according to any of the first to third aspects, wherein the component (B) is a hydrogenated copolymer of dicyclopentadiene and an aromatic compound.

A fifth aspect of the present invention is the temporary fixing composition according to any of the first to fourth aspects, wherein the component (B) is included in an amount of 100 to 600 parts by weight based on 100 parts by weight of the component (A).

A sixth aspect of the present invention is the temporary fixing composition according to any of the first to fifth aspects, wherein the component (C) includes a hydrocarbon compound having a softening point of 60 to 100° C. and a hydrocarbon compound having a melting point of 40 to 80° C.

A seventh aspect of the present invention is the temporary fixing composition according to the first to sixth aspects, wherein the component (C) is included in an amount of 1 to 600 parts by weight based on 100 parts by weight of the component (A).

### Effects of Invention

The temporary fixing composition of the present invention does not cause the deformation due to cure shrinkage, because it is a non-reactive temporary fixing composition. According to the temporary fixing composition of the present invention, the wafers and the like and the metals can be fixed with a high adhesive strength, and the temporary fixing composition can be easily and completely released from the wafers and the like and the metals without damage thereof. Further, the temporary fixing composition of the present invention has a low viscosity when it is heated, thus resulting in good workability.

### BRIEF DESCRIPTION OF DRAWINGS

FIG. 1 is an explanation view of method for measuring a shear strength.

FIG. 2 is a side view of a specific example of chemical mechanical polishing.

FIG. 3 is a top view of FIG. 2.

### DESCRIPTION OF EMBODIMENTS

One embodiment of the present invention is a temporary fixing composition used for flat surface polishing which includes a component (A): a thermoplastic resin polymerized from an α-olefin having 16 to 35 carbon atoms alone; a component (B): a hydrogenated tackifier; and a component (C): a hydrocarbon compound which is in the state of a solid at 25° C., and having a melt viscosity of 1 to 5000 mPa·s at 100° C. and a Shore D hardness of 30 to 100.

In addition, another embodiment of the present invention is a temporary fixing composition used for metal grinding, which includes a component (A): a thermoplastic resin polymerized from an α-olefin having 16 to 35 carbon atoms alone; a component (B): a hydrogenated tackifier; and a component (C): a hydrocarbon compound which is in the state of a solid at 25° C., and having a melt viscosity of 1000 to 20000 mPa·s at 100° C. and a Shore D hardness of 20 to 50.

The temporary fixing compositions of the present invention are non-reactive compositions which do not use a starting material in which reactive functional groups are cross-linked to provide a high molecular weight compound. The temporary fixing composition is preferable in the state of a solid at 25° C.

When the temporary fixing composition of the present invention is temporarily fixed on wafers and the like and metals, the surface processing of the wafers and the like and the metals can be efficiently performed.

The present invention will be explained in detail below. The specific composition of the temporary fixing composition of the present invention is not particularly limited, and the composition includes the component (A), the component (B), and the component (C) as essential components.

### [Component (A)]

The component (A) which can be used in the present invention is a thermoplastic resin polymerized from an α-olefin having 16 to 35 carbon atoms (hereinafter which may be referred to as a “higher olefin”) alone. When the number of carbon atoms of the α-olefin is 16 or less, the resulting polymer has low crystallizability, and thus it tends to reduce the hardness. When the number of carbon atoms of the α-olefin is 35 or more, the resulting polymer has a wide melt temperature range and a wide crystallization temperature range, the olefin tends to be ununiform.

The higher olefin is not particularly limited, and may include 1-hexadecene, 1-heptadecene, 1-octadecene, 1-nonadecene, 1-eicosen. The higher olefins may be used alone or as a mixture of two or more kinds thereof.

Specific examples of the component (A) may include, but are not limited to, EL CRYSTA series manufactured by Idemitsu Kosan Co., Ltd. A method for producing the component (A) is not particularly limited, and it can be produced using a metallocene catalyst in a method described, for example, in JP-A-2005-75908 or WO 2003/070790.

The component (A) is preferably in the state of a solid in an atmosphere of 25° C. in terms of the workability.

### [Component (B)]

The component (B), which can be used in the invention, is the hydrogenated tackifier. The temporary fixing composition becomes hard by addition of the component (B).

The tackifier means a compound which is added to elastomer to provide an adhesive function, and specific examples thereof may include rosin derivatives, polyterpene resins.

Hydrogenation means addition of hydrogen for reduction of unsaturated bonds, or the like. In the instant specification, hydrogenation may sometimes be referred to as hydrogenation.

The hydrogenated tackifier is not particularly limited, and may include tackifiers in which a carbon-carbon unsaturated bond is hydrogenated. Of these, hydrogenated copolymers of dicyclopentadiene and an aromatic compound are preferable, and specific examples thereof may include hydrogenated resins in I-MARV series manufactured by Idemitsu Kosan Co., Ltd. In this case, partially hydrogenated resins may include S-100, S-110, and completely hydrogenated resins may include P-100, P-125, P-140. The completely hydrogenated resins are preferable as the tackifier.

The component (B) has preferably compatibility with the component (A). When the compatibility with the component (A) is high, the temporary fixing composition melt becomes transparent, and preferably the bleed-out is prevented when the melt is cooled, and tenacity of the temporary fixing composition at 25° C. becomes high.

It is preferable to add the component (B) in an amount of 100 to 600 parts by weight based on 100 parts by weight of the component (A). When the addition amount of the component (B) is 100 parts by weight or more, preferably the temporary fixing composition is hard, and thus the shape thereof can be easily maintained. On the other hand, when the addition amount of the component (B) is 600 parts by weight or less, the temporary fixing composition preferably becomes tenacious.

### [Component (C)]

The component (C), which can be used in the present invention, is a hydrocarbon compound which is in the state of a solid at 25° C. When the component (C) is added, the shear strength is improved.

The hydrocarbon compound is not particularly limited, so long as it is in the state of a solid at 25° C., and examples thereof may include thermoplastic resins, thermoplastic elastomers, rubber elastomers. The hydrocarbon compound may include not only saturated bonds but also unsaturated bonds.

Specific examples of the component (C) may include elastomers obtained by copolymerization of an α-olefin such as ethylene, propylene, 1-butene, 1-pentene, or 1-octene; elastomers obtained by copolymerization of the α-olefin described above with a cyclic olefin, a styrene monomer, a non-conjugated diene (dicyclopentadiene, 1,4-hexadiene, dicyclooctadiene, methylene norbornene, or 5-ethylidene-2-norbornene) (which are also referred to as “plastomers”), hydrocarbon waxes, EVA waxes. The other elastomers may include amorphous elastic copolymer including an olefin as a main component, such as ethylene.propylene copolymer elastomer, ethylene.1-butene copolymer elastomer, ethylene.propylene.1-butene copolymer elastomer, ethylene.1-hexene copolymer elastomer, ethylene.1-octene copolymer elastomer, ethylene.styrene copolymer elastomer, ethylene.norbornene copolymer elastomer, propylene.1-butene copolymer elastomer, ethylene.propylene.non-conjugateddiene copolymer elastomer, ethylene.1-butene-non-conjugated diene copolymer elastomer, ethylene.propylene.1-butene-non-conjugated diene copolymer elastomer.

Examples of the trademark may include, but are not limited to, polyolefin thermoplastic resins (for example, PARAFINWAX-115, PARAFINWAX-155, manufactured by Nippon Seiro Co., Ltd.), microcrystalline thermoplastic resins (for example, HI-MIC-1090, manufactured by Nippon Seiro Co., Ltd.), and the like.

In the component (C), the hydrocarbon wax and/or the EVA wax are particularly preferable.

The component (C) described above may be used alone or as a mixture of two or more kinds.

The component (C) preferably has compatibility with the component (A) and the component (B). The component (C) preferably has a softening point of 60 to 100° C. The component (C) preferably has a melting point of 40 to 80° C. When two or more kinds of compounds are mixed in the components (C), it is preferable that the component (C) includes a hydrocarbon compound having a softening point of 60 to 100° C., and a hydrocarbon compound having a melting point of 40 to 80° C. When the component (C) includes the two or more kinds of the compounds as described above, the temporarily fixing composition can have an action of improving the tenacity at 25° C. and an action of reducing the melt viscosity. The hydrocarbon compound having a broad molecular weight distribution (polymers, and the like) is expressed by the softening point, and the hydrocarbon compound having a sharp molecular weight distribution (single-crystal compounds, and the like) is expressed by the melting point. When the component (C), accordingly, includes a hydrocarbon compound having a softening point of 60 to 100° C. and a hydrocarbon compound having a melting point of 40 to 80° C., the component (C) includes a polymer or the like, and a single-crystal compound or the like.

The component (C) is preferably added in an amount of 1 to 600 parts by mass based on 100 parts by mass of the component (A). When the addition amount of the component (C) is 1 part by mass or more, the sufficient strength can be preferably obtained. On the other hand, when the addition amount of the component (C) is 600 parts by mass or less, the melt viscosity is not too high, and it is preferable.

A compound which is in the state of liquid at 25° C. may be mixed with the temporary fixing composition of the present invention, in addition to the component (A) to the component (C). The compound which is in the state of liquid at 25° C. may be added in an amount within a range of 30 parts by mass or less based on 100 parts by mass of the component (A). When the addition amount of the compound which is in the state of liquid at 25° C. is 30 parts by mass or less, the temporary fixing composition can turn into a solid, and it is preferable. The compound which is in the state of liquid at 25° C. is different from the component (A) to the component (C).

The compound which is in the state of liquid at 25° C. is not particularly limited, and examples thereof may include hydrocarbon compounds such as isoparaffin hydrocarbons, paraffin oil, and paraffin hydrocarbons. Of these, compounds having compatibility with the components (A) to (C) are preferable.

In terms of the properties of the temporary fixing composition such as the Shore hardness and the shear strength, however, it is particularly preferable that the composition does not substantially include the compound which is in the state of liquid at 25° C. When the composition does not substantially include the compound which is in the state of liquid at 25° C., the temporary fixing composition tends to have the tenacity, it is difficult that the wafers and the like and the metals exfoliate during the grinding•and polishing, and thus the composition tends to have properties necessary for temporary fixation. The phrase “does not substantially include” includes a case in which the compound is not intentionally added, a case in which a slight amount of the liquid is intentionally added to some extent in which the viscosity is hardly influenced, a case in which the liquid component is intentionally contaminated in a starting material as an impurity, a case in which after the addition of the compound, the compound is dried to volatilize it.

To the temporary fixing composition of the present invention may be added additives within a range in which the predetermined effects of the present invention are not impaired, and the examples of the additive may include coloring agents such as a pigment and a dye; inorganic fillers such as metal powder, calcium carbonate, talc, silica, alumina, and aluminum hydroxide; flame retardants; organic fillers; plasticizers; anti-oxidants; antifoaming agents; silane coupling agents; leveling agents; rheology-controlling agents. When the additives is added, the temporary fixing composition having the high resin strength, the high adhesive strength, the good workability, the high storability can be obtained.

In one embodiment, the temporary fixing composition of the present invention is characterized by having a melt viscosity at 100° C. of 1 to 5000 mPa·s, preferably 100 to 8000 mPa·s, more preferably 500 to 5000 mPa·s. When the melt viscosity is less than 1 mPa·s, disadvantages are given to the temporary fixation due to the surface tension. On the other hand, when it is more than 5000 mPa·s, the viscosity is too high and stringiness is caused, and thus the handling is difficult. The temporary fixing composition of this embodiment is mainly used for the surface processing (flat surface polishing, and the like) of the wafers and the like. In the specification, a method described in Example is applied to the method for measuring the melt viscosity.

In another embodiment, the temporary fixing composition of the present invention is characterized by having a melt viscosity at 100° C. of 1000 to 20000 mPa·s, preferably 2000 to 20000 mPa·s, more preferably 2000 to 15000 mPa·s. When the melt viscosity is less than 1000 mPa·s, the sufficient strength cannot be obtained, and thus the temporary fixing composition is deformed due to the weight of the metals and the like. On the other hand, when it is more than 20000 mPa·s, the wettability to the metals and the like is too low, and the shear strength is reduced. The temporary fixing composition of this embodiment is mainly used for the surface processing (the grinding, and the like) of the metals.

In one embodiment, the temporary fixing composition of the present invention is characterized by having a Shore D hardness of 30 to 100, preferably 30 to 90, more preferably 30 to 80. When the Shore D hardness is less than 30, the adherend cannot be held. On the other hand, when the Shore D hardness is more than 100, the composition is too brittle, and thus it is difficult to exhibit the shear strength. The temporary fixing composition of this embodiment is mainly used for the surface processing (flat surface polishing, and the like) of the wafers and the like. In the specification, a method described in Example is applied to the method for measuring the Shore D hardness.

In another embodiment, the temporary fixing composition of the present invention is characterized by having a Shore D hardness of 20 to 50, preferably 30 to 50. When the Shore D hardness is less than 20, the temporary fixing composition is too much soft, the metals and the like cannot be sufficiently temporarily fixed. On the other hand, when the Shore D hardness is more than 50, the temporary fixing composition is too much hard, and thus it is brittle and it may be removed from the metals and the like. The temporary fixing composition of this embodiment is mainly used for the surface processing (grinding, and the like) of the metals.

In one embodiment of the present invention, when the temporary fixing composition is used for the surface processing of the wafers and the like, the temporary fixing composition has preferably a Shore A hardness of 80 or more, more preferably 90 or more. When the Shore A hardness is 80 or more, the temporary fixing composition is preferably hard. In the specification, a method described in Example is applied to the method for measuring the Shore A hardness.

In another embodiment of the present invention, when the temporary fixing composition is used for the surface processing of the metals and the like, the temporary fixing composition has preferably a Shore A hardness of 80 or more. When the Shore A hardness is 80 or more, the temporary fixing composition can be hard, and it is preferable.

In one embodiment of the present invention, when the temporary fixing composition is used for the surface processing of the wafers and the like, the temporary fixing composition has preferably a shear strength of 0.05 MPa or more, more preferably 0.05 to 0.3 MPa. When the shear strength is 0.05 MPa or more, the adherend can be suitably held, and it is preferable. A method described in Example is applied to the method for measuring the shear strength.

In another embodiment of the present invention, when the temporary fixing composition is used for the surface processing of the metals and the like, the temporary fixing composition has preferably a shear strength of 0.15 MPa or more, more preferably 0.15 to 0.4 MPa. When the shear strength is 0.15 MPa or more, even an adherend having a high specific gravity can be sufficiently held, and it is preferable.

The temporary fixing composition of the present invention is preferably in the state of a solid at room temperature, and when it is handled, it may be in various shapes such as a powder, a mass, and a bar. The temporary fixing composition of the present invention may be used in the state of a sheet (hereinafter which may be referred to as the “sheet-shaped temporary fixing composition”).

In this case, a substrate which can be used is not particularly limited so long as it is sheet-shaped and has pores, and examples thereof may include porous sheets, non-woven paper and fabrics, woven fabrics, knitted fabrics, meshes. Of these, it is preferable to use the non-woven paper and fabric, the porous sheet and the mesh, because they have a variety of kinds and the cost thereof is cheap. In addition, plastic or polymer materials may also be used as the substrate. Examples of such a material may include nylon, polyester, polypropylene, polyethylene.

In a sheet having pores inside of the substrate, a rate of pores to the whole volume is shown by a pore rate (%). The substrate has preferably a pore rate of 50 to 95%. In a mesh cloth substrate, a pore is shown by an open area (%). The substrate has preferably an open area of 20 to 80%.

The sheet-shaped temporary fixing composition can be produced by impregnating the pores of the substrates with the composition. More specifically, when the temporary fixing composition does not include a volatile component, the sheet-shaped temporary fixing composition can be produced by impregnating the substrate with the temporary fixing composition, which is a molten state by heating, and cooling and solidifying it. On the other hand, when the temporary fixing composition includes a volatile component, the sheet-shaped temporary fixing composition may be produced by impregnating the substrate with the temporary fixing composition, and heating the temporary fixing composition at a temperature equal to or less than the melting point of the composition to volatilize the volatile component.

The sheet-shaped temporary fixing composition has preferably a thickness of 10 μm to 1 mm. When the sheet-shaped temporary fixing composition has a thickness of 10 μm or more, the wafers and the like and the metals can be sufficiently fixed, and peeling-off can be prevented, and it is preferable. On the other hand, when the sheet-shaped temporary fixing composition has a thickness of 1 mm or less, the sheet-shaped temporary fixing composition having a uniform thickness can be formed, the occurrence of inclination can be prevented, and it is preferable.

The temporary fixing composition of the present invention is non-reactive and thus is not shrunk by curing, and stress is hardly applied to the wafers and the like and the metals and thus the occurrence of deformation and the like can be prevented. As a result, the composition can be applied to the surface processing of a thin film of the wafer or metal having a thickness of less than 100 μm. In addition, because the temporary fixing composition of the present invention is hard, accuracy of dimension is high during the surface processing, and thus it is suitable for polishing or grinding application. Further, because of the low melt viscosity at 100° C., the handling such as formation of a coating film is excellent, and the composition can be easily removed from the wafers and the like after the surface processing.

### [Wafers and the Like/Metals]

The wafers and the like, which can be used, are not particularly limited, and examples thereof may include silicon wafers, sapphire glass, ceramic materials, optical glass, crystals, magnetic materials. More specifically, examples thereof may include optical glass (lenses, prisms, PBS, and optical filters), glass for electronic parts, quartz glass (synthesized quartz, and molten quartz), crystals (crystal radiator plates, SAW, optical low-pass filters), lithium niobate LiNbO₃, lithum tantalate LiTaO₃, magnesium oxide MgO, samarium cobalt SmCo, neodymium iron boron NbFeB, ferite (hard ferite, and soft ferite), barium titanate BaTiO₃, potassium titanate, zirconia ZrO₂, silicon nitride Si₃N₄, aluminum nitride AlN, alumina Al₂O₃, sapphire, piezoelectric ceramics PZT, machinable ceramics.

The wafers and the like may contain crystal phases which are grown on substrate crystals as a basis with epitaxy maintaining a certain crystal orientation relationship between the crystal phases and the substrate crystals (epitaxial growth).

The metals which can be used may include iron, stainless steel, aluminum.

The wafers and the like have preferably a large diameter, specifically a diameter of 6 inches or more.

Although it is not particularly limited, 500 to 1000 μm wafers and the like are preferable.

The thickness of the wafers and the like is not particularly limited after the surface processing, but it is preferable to control the thickness to 50 to 200 μm.

### [Application of Temporary Fixing Composition]

The temporary fixing composition of this embodiment is non-reactive, has the high adhesive strength, and can be removed easily and completely. The composition, accordingly, is preferably applied to the temporary fixation when the wafers and the like and the metals are subjected to the surface processing (polishing, grinding, and the like).

The wafers and the like and the metals can be temporarily fixed by spin-coating of the temporary fixing composition. Specifically, the wafers and the like or the metals are statically put on a stand (carrier), and the temporary fixing composition is diffused by centrifugal force while the stand is rotated, whereby a uniform film of the temporary fixing composition is formed on the wafers and the like or the metals.

The temporary fixing composition is preferably in the state of liquid at 25° C. when the wafers and the like or the metals are temporarily fixed, in terms of the workability. When the temporary fixing composition is in the state of a solid at 25° C., a slight amount of liquid may be intentionally added thereto to an extent in which the viscosity is hardly influenced. In addition, a liquid component may be intentionally added to the composition, thereby obtaining the composition in a liquid state. In this case, the liquid component, which has been added, can be removed by hot-air drying, or the like after the spin-coating, whereby the temporary fixing composition, “which does not substantially include a compound in the state of liquid at 25° C.,” can be obtained.

As the method for fixing the wafers and the like or the metals with the temporary fixing composition, known coating method can be utilized in addition to the spin-coating.

When a target of the surface processing is the wafers and the like, the flat surface polishing is usually performed. According to this embodiment, therefore, the temporary fixing composition used for the flat surface polishing is provided.

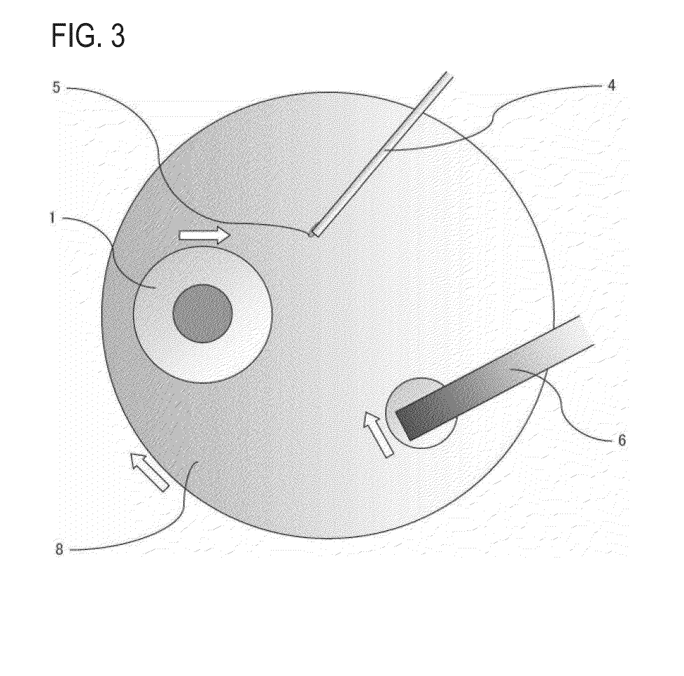

The polishing as the surface processing is mainly chemical mechanical polishing. The chemical mechanical polishing is, more specifically, a technique in which a mechanical polishing (surface removing) effect due to relative motion between a polishing agent and a target of the polishing is increased by a surface chemical action of the polishing agent (abrasive grains) itself, or an action of a chemical component in the polishing agent to obtain a smooth polished surface in a high speed. The chemical mechanical polishing is also expressed as a chemical-mechanical polishing, chemically mechanical polishing, chemical and mechanical polishing, CMP or the like. FIG. 2 is a side view showing a chemical mechanical polishing in one embodiment, and FIG. 3 is a top view of FIG. 2.

When the target of the surface processing is the metal, the metal grinding is usually performed. According to this embodiment, therefore, the temporary fixing composition used for metal grinding is provided.

The temporary fixing composition of this embodiment is hard, and the accuracy of dimension thereof is high in the surface processing, and thus it can be preferably used for accurate grinding of a metal. In particular, the temporary fixing composition is suitable for grinding necessary for accuracy. Specific examples of the grinding may be exemplified mainly by abrasive grain processing. Typical mode of the processing may include a processing using loose abrasive grains, in which slurry is used, a processing using abrasive grains fixed with a binding material, a belt grinding, honing, and the like.

### EXAMPLE

The present invention will be explained in more detail by means of Examples below, but the invention is not limited to Examples alone. In Examples described below, the temporary fixing composition may also be referred to as the “composition.”

### [Confirmation of Compatibility]

First, the compatibilities of components (A) to (C), a component (B′), and a component (C′) were confirmed. More specifically, the component (A) was first heated and molten. At that time, the melting temperature was appropriately varied depending on the component (A) used. Next, the component (B) or (B′) was added to the molten component (A), and the mixture was stirred for 15 minutes until the mixture was uniform. After that, the component (C) or (C′) was added thereto, and the mixture was stirred for further 15 minutes to obtain a composition. Table 1 shows detailed preparation amounts, wherein all of the numbers are parts by mass.

The compatibilities of the obtained mixtures were confirmed. The compatibility was confirmed in a visual observation, and when the mixture was transparent, it was evaluated to have “compatibility” and when the mixture was non-transparent due to occurrence of muddiness, it was evaluated to have “non-compatibility”. The obtained results are shown in Table 1.

### (Confirmations 1 to 30)

Component (A): A thermoplastic resin polymerized from an α-olefin having 16 to 35 carbon atoms alone (which was solid at 25° C.)
A thermoplastic resin having a melting point of 70° C. (EL CRYSTA C-7100 manufactured by Idemitsu Kosan Co., Ltd.)
A thermoplastic resin having a melting point of 40° C. (EL CRYSTA C-4100 manufactured by Idemitsu Kosan Co., Ltd.)

Component (B): Hydrogenated tackifier (which was solid at 25° C.)
I-MARV P-100 (manufactured by Idemitsu Kosan Co., Ltd.)
I-MARV P-125 (manufactured by Idemitsu Kosan Co., Ltd.)
I-MARV P-140 (manufactured by Idemitsu Kosan Co., Ltd.)

Component (C): A hydrocarbon compound which was solid at 25° C.

Hydrocarbon Wax
Hi-Mic-1090 (which was solid at 25° C.) (manufactured by Nippon Seiro Co., Ltd.)
LUVAX-2191 (which was solid at 25° C.) (manufactured by Nippon Seiro Co., Ltd.)
PARAFFIN WAX-115 (which was solid at 25° C.) (manufactured by Nippon Seiro Co., Ltd.)
PARAFFIN WAX-130 (which was solid at 25° C.) (manufactured by Nippon Seiro Co., Ltd.)
PARAFFIN WAX-155 (which was solid at 25° C.) (manufactured by Nippon Seiro Co., Ltd.)
Licocene PP 1602 (which was solid at 25° C.) (manufactured by Clariant)

EVA Wax
Ultrathene 7A55A (which was solid at 25° C.) (manufactured by Tosoh Corporation)
P-100A (which was solid at 25° C.) (manufactured by Tosoh Corporation)

Component (B′): Components other than Component (B) (which was solid at 25° C.)

Non-Hydrogenated Tackifier
I-MARVS-100 (Manufactured by Idemitsu Kosan Co., Ltd.)
I-MARVS-110 (Manufactured by Idemitsu Kosan Co., Ltd.)

Component (C′): Components other than Component (C)

Hydrocarbon Wax (which was liquid at 25° C.)
IP Solvent 2835 (manufactured by Idemitsu Kosan Co., Ltd.)
LINEALENE PAO V-50 (manufactured by Idemitsu Kosan Co., Ltd.)

SEBS Rubber Elastomer (which was solid at 25° C.)
FG 1901 X (manufactured by KRATON)
G 1726 M (manufactured by KRATON)

SIBS Rubber Elastomer (which was solid at 25° C.)
SIBSTAR 102 T (manufactured by Kaneka Corporation)
SIBSTAR 103 T (manufactured by Kaneka Corporation)

Rubber Elastomer (which was solid at 25° C.)
HYBRAR 7125 (manufactured by Kuraray Co., Ltd.)

Polyamide Elastomer (which was solid at 25° C.)
sebacic acid (manufactured by ITOH OIL CHEMICALS Co., Ltd.)
1,2-hydroxystearic acid (manufactured by ITOH OIL CHEMICALS Co., Ltd.)
hydrogenated castor oil (manufactured by ITOH OIL CHEMICALS Co., Ltd.)
A-S-A T-1700 (manufactured by ITOH OIL CHEMICALS Co., Ltd.)
A-S-A T-1800 (manufactured by ITOH OIL CHEMICALS Co., Ltd.)
ITOHWAX J-420 (manufactured by ITOH OIL CHEMICALS Co., Ltd.)
ITOHWAX J-500 (manufactured by ITOH OIL CHEMICALS Co., Ltd.)
ITOHWAX J-530 (manufactured by ITOH OIL CHEMICALS Co., Ltd.)
ITOHWAX J-630 (manufactured by ITOH OIL CHEMICALS Co., Ltd.)
ITOHWAX J-700 (manufactured by ITOH OIL CHEMICALS Co., Ltd.)

TABLE 1

| | Starting | Confirmation | Confirmation | Confirmation | Confirmation | Confirmation | Confirmation | Confirmation | Confirmation | Confirmation | Confirmation | Confirmation |
|---|---|---|---|---|---|---|---|---|---|---|---|---|
| Component | Material | 1 | 2 | 3 | 4 | 5 | 6 | 7 | 8 | 9 | 10 | 11 |
| Component | X-C-4100 | 10 | 10 | 10 | 10 | 10 | 10 | 10 | 10 | 10 | 10 | 10 |
| (A) | | | | | | | | | | | | |
| Component | I-MARV P-100 | 10 | | | | | | | | | | |
| (B) | I-MARV P-125 | | 10 | | | | | | | | | |
| | I-MARV P-140 | | | 10 | | | | | | | | |
| Component | Hi-Mic-1090 | | | | 10 | | | | | | | |
| (C) | LUVAX-2191 | | | | | 10 | | | | | | |
| | PARAFFIN | | | | | | 10 | | | | | |
| | WAX-115 | | | | | | | | | | | |
| | PARAFFIN | | | | | | | 10 | | | | |
| | WAX-130 | | | | | | | | | | | |
| | PARAFFIN | | | | | | | | 10 | | | |
| | WAX-155 | | | | | | | | | | | |
| | Licocene PP 1602 | | | | | | | | | 10 | | |
| | Ultrathene 7A55A | | | | | | | | | | 10 | |
| | P-100A | | | | | | | | | | | 10 |

| | | | | | | | | | | | |
|---|---|---|---|---|---|---|---|---|---|---|---|
| Total | 20 | 20 | 20 | 20 | 20 | 20 | 20 | 20 | 20 | 20 | 20 |
| Confirmation of compatibility | Compatibility | Compatibility | Compatibility | Compatibility | Compatibility | Compatibility | Compatibility | Compatibility | Compatibility | Compatibility | Compatibility |

| | Starting | Confirmation | Confirmation | Confirmation | Confirmation | Confirmation | Confirmation | Confirmation | Confirmation | Confirmation | Confirmation |
|---|---|---|---|---|---|---|---|---|---|---|---|
| Component | material | 12 | 13 | 14 | 15 | 16 | 17 | 18 | 19 | 20 | 21 |
| Component | X-C-4100 | 10 | 10 | 10 | 10 | 10 | 10 | 10 | 10 | 10 | 10 |
| (A) | | | | | | | | | | | |
| Component | I-MARV S-100 | 10 | | | | | | | | | |
| (B′) | I-MARV S-110 | | 10 | | | | | | | | |
| Component | IP solvent 2835 | | | 10 | | | | | | | |
| (C′) | LINEALENE | | | | 10 | | | | | | |
| | PAO V-50 | | | | | | | | | | |
| | FG1901X | | | | | 10 | | | | | |
| | G1726M | | | | | | 10 | | | | |
| | SIBSTAR | | | | | | | 10 | | | |
| | 102T | | | | | | | | | | |
| | SIBSTAR | | | | | | | | 10 | | |
| | 103T | | | | | | | | | | |
| | HYBRAR 7125 | | | | | | | | | 10 | |
| | Sebacic acid | | | | | | | | | | 10 |
| | 1,2-Hydroxyste | | | | | | | | | | |
| | aric acid | | | | | | | | | | |
| | Hydrogenated | | | | | | | | | | |
| | castor oil | | | | | | | | | | |
| | A-S-A T-1700 | | | | | | | | | | |
| | A-S-A T-1800 | | | | | | | | | | |
| | ITOHWAX | | | | | | | | | | |
| | J-420 | | | | | | | | | | |
| | ITOHWAX | | | | | | | | | | |
| | J-500 | | | | | | | | | | |
| | ITOHWAX | | | | | | | | | | |
| | J-530 | | | | | | | | | | |
| | ITOHWAX | | | | | | | | | | |
| | J-630 | | | | | | | | | | |
| | ITOHWAX | | | | | | | | | | |
| | J-700 | | | | | | | | | | |

| | | | | | | | | | | |
|---|---|---|---|---|---|---|---|---|---|---|
| Total | 20 | 20 | 0 | 0 | 10 | 10 | 10 | 10 | 10 | 10 |
| Confirmation of compatibility | Non- | Non- | Compatibility | Compatibility | Non- | Non- | Non- | Non- | Non- | Non- |
| | compatibility | compatibility | | | compatibility | compatibility | compatibility | compatibility | compatibility | compatibility |

| | Starting | Confirmation | Confirmation | Confirmation | Confirmation | Confirmation | Confirmation | Confirmation | Confirmation | Confirmation |
|---|---|---|---|---|---|---|---|---|---|---|
| Component | material | 22 | 23 | 24 | 25 | 26 | 27 | 28 | 29 | 30 |
| Component | X-C-4100 | 10 | 10 | 10 | 10 | 10 | 10 | 10 | 10 | 10 |
| (A) | | | | | | | | | | |
| Component | I-MARV S-100 | | | | | | | | | |
| (B′) | I-MARV S-110 | | | | | | | | | |
| Component | IP solvent 2835 | | | | | | | | | |
| (C′) | LINEALENE PAO V-50 | | | | | | | | | |
| | FG1901X | | | | | | | | | |
| | G1726M | | | | | | | | | |
| | SIBSTAR 102T | | | | | | | | | |
| | SIBSTAR 103T | | | | | | | | | |
| | HYBRAR 7125 | | | | | | | | | |
| | Sebacic acid | | | | | | | | | |
| | 1,2-hydroxystearic acid | 10 | | | | | | | | |
| | Hydrogenated castor oil | | 10 | | | | | | | |
| | A-S-A T-1700 | | | 10 | | | | | | |
| | A-S-A T-1800 | | | | 10 | | | | | |
| | ITOHWAX J-420 | | | | | 10 | | | | |
| | ITOHWAX J-500 | | | | | | 10 | | | |
| | ITOHWAX J-530 | | | | | | | 10 | | |
| | ITOHWAX J-630 | | | | | | | | 10 | |
| | ITOHWAX J-700 | | | | | | | | | 10 |

| | | | | | | | | | |
|---|---|---|---|---|---|---|---|---|---|
| Total | 10 | 10 | 10 | 10 | 10 | 10 | 10 | 10 | 10 |
| Confirmation of compatibility | Non- | Non- | Non- | Non- | Non- | Non- | Non- | Non- | Non- |
| | compatibility | compatibility | compatibility | compatibility | compatibility | compatibility | compatibility | compatibility | compatibility |

### [Production of Temporary Fixing Composition Used for Flat Surface Polishing of Wafers and the Like]

### Examples 1 to 20 and Comparative Examples 1 to 19

A temporary fixing composition was produced appropriately combining the following components (A) to (C). More specifically, after the component (A) was molten, first the component (A) was heated and molten. At that time, the melting temperature was varied depending on the component (A) used. Next, the component (B) was added to the molten component (A), and the mixture was stirred for 15 minutes until the mixture was uniform. After that, the component (C) was added thereto, and the mixture was stirred for further 15 minutes to obtain a temporary fixing composition. Table 2 shows detailed preparation amounts, wherein all of the numbers are parts by mass. When the temporary fixing composition did not include the component (B), the addition of the component (B) and the stirring were omitted.

Component (A): A thermoplastic resin polymerized from an α-olefin having 16 to 35 carbon atoms alone
A thermoplastic resin having a melting point of 70° C. (EL CRYSTA C-7100 manufactured by Idemitsu Kosan Co., Ltd.)
A thermoplastic resin having a melting point of 40° C. (EL CRYSTA C-4100 manufactured by Idemitsu Kosan Co., Ltd.)

Component (B): Hydrogenated tackifier
I-MARV P-100 (manufactured by Idemitsu Kosan Co., Ltd.)

Component (C): A hydrocarbon compound which was solid at 25° C.
Licocene PP 1602 (a softening point: 85 to 91° C.) (manufactured by Clariant)
PARAFFIN WAX-115 (a melting point: 69° C.) (manufactured by Nippon Seiro Co., Ltd.)
PARAFFIN WAX-130 (a melting point: 55° C.) (manufactured by Nippon Seiro Co., Ltd.)
PARAFFIN WAX-155 (a melting point: 47° C.) (manufactured by Nippon Seiro Co., Ltd.)

Others
IP Solvent 2835 (which was liquid at 25° C.) (Manufactured by Idemitsu Kosan Co., Ltd.)

TABLE 2

| Component | Starting material | Example 1 | Example 2 | Example 3 | Example 4 | Example 5 | Example 6 | Example 7 | Example 8 | Example 9 | Example 10 |
|---|---|---|---|---|---|---|---|---|---|---|---|
| Component (A) | X-C-7100 | 100 | 100 | 100 | 100 | 100 | 100 | 100 | 100 | 100 | |
| | X-C-4100 | | | | | | | | | | 100 |
| Component (B) | I-MARV P-100 | 100 | 100 | 200 | 200 | 300 | 300 | 300 | 300 | 500 | 100 |
| Component (C) | Licocene PP 1602 | 100 | 100 | 200 | 200 | 25 | 125 | 200 | 300 | 40 | 5 |
| | PARAFFIN WAX-155 | 100 | | 300 | | 25 | | | | | |
| | PARAFFIN WAX-130 | | 100 | | 300 | | 25 | 200 | 200 | 100 | |
| | PARAFFIN WAX-115 | | | | | | | | | | |
| Others | IP Solvent 2835 | | | | | | | | | | |
| Total | | 400 | 400 | 800 | 800 | 450 | 550 | 800 | 900 | 740 | 205 |
| Component | Starting material | Example 11 | Example 12 | Example 13 | Example 14 | Example 15 | Example 16 | Example 17 | Example 18 | Example 19 | Example 20 |
| Component (A) | X-C-7100 | | | | | | | | | | |
| | X-C-4100 | 100 | 100 | 100 | 100 | 100 | 100 | 100 | 100 | 100 | 100 |
| Component (B) | I-MARVP-100 | 100 | 100 | 200 | 300 | 300 | 300 | 300 | 300 | 300 | 100 |
| Component (C) | Licocene PP 1602 | 20 | 100 | 200 | 25 | 25 | 25 | 125 | 200 | 300 | 100 |
| | PARAFFIN WAX-155 | | | | | | | | | | |
| | PARAFFIN WAX-130 | | 100 | 300 | 100 | | 25 | 25 | 200 | 200 | |
| | PARAFFIN WAX-115 | | | | | 25 | | | | | |
| Others | IP SOLVENT 2835 | | | | | | | | | | 30 |
| Total | | 220 | 400 | 800 | 525 | 450 | 450 | 550 | 800 | 900 | 330 |
| | | Comparative | Comparative | Comparative | Comparative | Comparative | Comparative | Comparative | Comparative | Comparative | Comparative |
| Component | Starting material | Example 1 | Example 2 | Example 3 | Example 4 | Example 5 | Example 6 | Example 7 | Example 8 | Example 9 | Example 10 |
| component (A) | X-C-7100 | | | | | | | | | | |
| | X-C-4100 | 100 | | | 100 | 100 | | | 100 | 100 | 100 |
| Component (B) | I-MARVP-100 | | 100 | | | | 100 | 100 | 150 | 100 | 100 |
| Component (C) | Licocene PP 1602 | | | 100 | 100 | 100 | 100 | 100 | | | |
| | PARAFFIN WAX-155 | | | | | | 200 | | | | |
| | PARAFFIN WAX-130 | | | | | | | | 50 | | |
| | PARAFFIN WAX-115 | 100 | 100 | 100 | | 200 | | 200 | | 100 | 200 |
| Others | IP SOLVENT 2835 | | | | | | | | | | |

| | | | | | | | | | | |
|---|---|---|---|---|---|---|---|---|---|---|
| Total | 200 | 200 | 200 | 200 | 400 | 400 | 400 | 300 | 300 | 400 |

| | | Comparative | Comparative | Comparative | Comparative | Comparative | Comparative | Comparative | Comparative | Comparative |
|---|---|---|---|---|---|---|---|---|---|---|
| Component | Starting material | Example 11 | Example 12 | Example 13 | Example 14 | Example 15 | Example 16 | Example 17 | Example 18 | Example 19 |
| Component (A) | X -C-7100 | | 100 | | | | | | | |
| | X-C-4100 | 100 | | 100 | 100 | 100 | 100 | 100 | 100 | 100 |
| Component (B) | I-MARVP-100 | 200 | 20 | 20 | 60 | 250 | 400 | 250 | 400 | 100 |
| Component (C) | Licocene PP 1602 | | 20 | 10 | 60 | 25 | 50 | 125 | 200 | 100 |
| | PARAFFIN WAX-155 | | 100 | | | | | | | |
| | PARAFFIN WAX-130 | | | | 30 | | | | | |
| | PARAFFIN WAX-115 | 300 | | | | | | 25 | 100 | |
| Others | IP SOLVENT 2835 | | | | | | | | | 30 |

| | | | | | | | | | |
|---|---|---|---|---|---|---|---|---|---|
| Total | 600 | 240 | 130 | 250 | 375 | 550 | 500 | 800 | 330 |

### [Evaluation of Physical Property]

Physical properties of the temporary fixing compositions produced in Examples 1 to 20 and Comparative Examples 1 to 19 above were evaluated.

### (Measurement of Melt Viscosity)

The melt viscosity was measured under conditions described below. The obtained results are shown in Table 3. When the composition was liquid at 25° C., “Liquid” is described in the Table.

RVT manufactured by Brookfield LTD. (Brookfield•thermocell system)

Spindle: SC4-21

Speed of Revolution: 5, 10, 20, 50, or 100 rpm, which was appropriately changed depending on the viscosity of the composition.

Measurement Temperature: 100° C.

### (Measurement of Shore Hardness)

After the temporary fixing composition produced as above was formed into a cylinder shape, a surface which was brought into contact with a pressure standard surface was made parallel to a surface which was brought into contact with a measurement stand, which surfaces facing each other. The formed temporary fixing composition was put on the measurement stand, and the pressure standard surface of a durometer was pressed to and closely contacted with the surface of the temporary fixing composition while the pressure stand surface was maintained in parallel to the sample surface without impact. At that time, a push needle of the durometer was separated 12 mm or more from the edge of the temporary fixing composition. The push needle of the durometer was pressed to the temporary fixing composition with a predetermined force, and the maximum value obtained at that time was defined as a “shore hardness”. The measurement temperature was 25° C. A value obtained when a force of 10 N (1 kgf) was pressed to the composition is a Shore A hardness, and a value obtained when a force of 50 N (5 kgf) was pressed to the composition is a Shore D hardness. The obtained results are shown in Table 3. The hardness of 100 was written as “the upper limit value” and the composition which was liquid at 25° C. was written as “impossible to measure” in Table.

### (Measurement of Shear Strength)

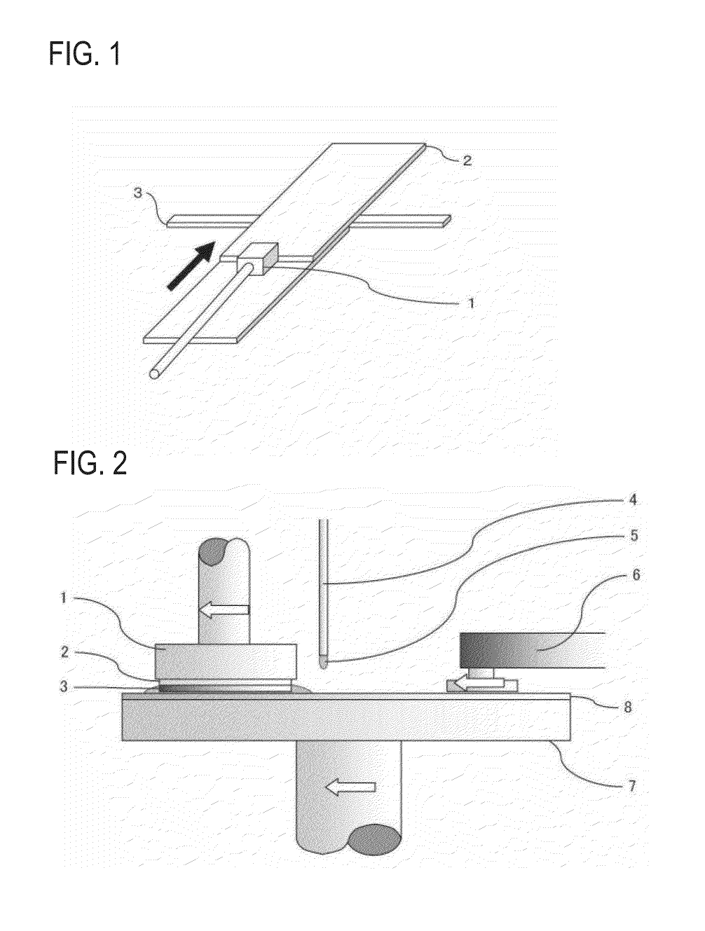

The temporary fixing composition produced as above was coated on a glass plate described below, while the composition was warmed, and alignment of the glass plate and bonding were performed. After that, as shown in FIG. 1, the glass plate was temporarily fixed, a digital force gauge was moved at a predetermined moving speed, and a strength (N) was measured when the head of the digital force gauge was brought into contact with the glass plate in a shear direction to the adhesive surface. A strength per adhesive surface (m²) was defined as a “shear strength (MPa)”. The obtained results are shown in Table 3, wherein “impossible to measure” refers to a case in which the composition was liquid at 25° C. When the shear strength is less than 0.05 MPa, it can be said that it is not suitable generally for temporary fixation.

Glass Plate: 5.0×25×100 mm

Adhesive Area: 25×10 mm

Strength Measuring Instrument: Digital force gauge FGC-10 manufactured by NIDEC-SHIMPO Corporation

Moving Speed of Strength Measuring Instrument: 10 mm/min

TABLE 3

| Test Item | Example 1 | Example 2 | Example 3 | Example 4 | Example 5 | Example 6 | Example 7 | Example 8 | Example 9 | Example 10 |
|---|---|---|---|---|---|---|---|---|---|---|
| Melt viscosity | 800 | 645 | 560 | 415 | 2510 | 4750 | 310 | 905 | 960 | 1250 |
| Shore A hardness | 96 | 95 | 92 | 92 | Upper limit value | Upper limit value | 96 | 95 | Upper limit value | 82 |
| Shore D hardness | 43 | 41 | 34 | 33 | 62 | 50 | 40 | 38 | 56 | 32 |
| Shear strength | 0.08 | 0.08 | 0.14 | 0.13 | 0.07 | 0.14 | 0.10 | 0.13 | 0.08 | 0.12 |
| Test Item | Example 11 | Example 12 | Example 13 | Example 14 | Example 15 | Example 16 | Example 17 | Example 18 | Example 19 | Example 20 |
| Melt viscosity | 2015 | 530 | 370 | 960 | 1970 | 2310 | 4250 | 250 | 830 | 220 |
| Shore A hardness | 81 | 86 | 88 | Upper limit value | Upper limit value | Upper limit value | Upper limit value | 92 | 95 | 78 |
| Shore D hardness | 32 | 80 | 33 | 56 | 62 | 60 | 48 | 32 | 32 | 30 |
| Shear strength | 0.21 | 0.12 | 0.13 | 0.08 | 0.07 | 0.10 | 0.13 | 0.15 | 0.14 | 0.11 |
| | Comparative | Comparative | Comparative | Comparative | Comparative | Comparative | Comparative | Comparative | Comparative | Comparative |
| Test Item | Example 1 | Example 2 | Example 3 | Example 4 | Example 5 | Example 6 | Example 7 | Example 8 | Example 9 | Example 10 |
| Melt viscosity | 100 | Liquid | Liquid | 4050 | 3110 | 863 | 405 | 1500 | 600 | 350 |
| Shore A hardness | 85 | Impossible to | Impossible to | 88 | 86 | 84 | 81 | 92 | 90 | 84 |
| | | measure | measure | | | | | | | |
| Shore D hardness | 22 | Impossible to | Impossible to | 25 | 23 | 21 | 21 | 28 | 28 | 25 |
| | | measure | measure | | | | | | | |
| Shear strength | 0.02 | Impossible to | Impossible to | 0.12 | 0.12 | 0.03 | 0.06 | 0.02 | 0.02 | 0.08 |
| | | measure | measure | | | | | | | |

| | Comparative | Comparative | Comparative | Comparative | Comparative | Comparative | Comparative | Comparative | Comparative |
|---|---|---|---|---|---|---|---|---|---|
| Test Item | Example 11 | Example 12 | Example 13 | Example 14 | Example 15 | Example 16 | Example 17 | Example 18 | Example 19 |
| Melt viscosity | 3500 | 250 | 735 | 2460 | 6770 | 14180 | 5205 | 10200 | 200 |
| Shore A hardness | 84 | 92 | 87 | 86 | 95 | Upper limit value | 95 | Upper limit value | 45 |
| Shore D hardness | 26 | 29 | 27 | 26 | 32 | 34 | 32 | 34 | 11 |
| Shear strength | 0.05 | 0.02 | 0.16 | 0.12 | 0.20 | 0.18 | 0.20 | 0.16 | 0.02 |

In Comparative Example 2, the component (A) was not included, and in Comparative Example 3, only the component (C) was included. Comparative Example 2 and Comparative Example 3 were liquid at 25° C., and it can be thought that it is caused by reduction of the crystallizability. On the other hand, in Comparative Example 1 in which the component (B) was not included, the solid state was maintained though the properties were not good.

In Comparative Example 6 and Comparative Example 7, it was seen that both the Shore D hardness and the shear strength were low, because the component (B) and the component (C) were included, but the component (A) was not included.

In Comparative Example 4 and Comparative Example 5 in which the component (B) was not included, and in Comparative Examples 13 and 14 in which the addition amount of the component (B) was less than 100 parts by mass based on 100 parts by mass of the component (A), the high shear strength was shown, but the Shore D hardness is less than 30, i.e., the hardness was low. Additionally, because the Shore A hardness is measured at a strength higher than that in the Shore D hardness, a contactor enters the temporary fixing composition, and thus it is difficult that the hardness is exhibited.

In Examples 1 to 20, the Shore A hardness was from 90 to 100 and the Shore D hardness was from 30 to 100, and thus they had high hardness. Even when the Shore A hardness is from 80 to 90, it can be used as the temporary fixing composition, if it has a shear strength of 0.10 MPa or more. In Examples 1 to 20, the melt viscosity was from 1 to 5000 mPa·s at 100° C., and thus the workability was good. On the other hand, in Comparative Examples 15 to 18, the melt viscosity was more than 5000 mPa·s at 100° C., and thus the workability was poor.

When the temporary fixing composition is used for the surface processing of the wafers and the like, the melt viscosity at 100° C. is from 1 to 5000 mPa·s, preferably from 100 to 8000 mPa·s, more preferably from 500 to 5000 mPa·s. In addition, the Shore D hardness is from 30 to 100, preferably from 30 to 90, more preferably from 30 to 80. Further the Shore A hardness is preferably 80 or more, more preferably 90 or more, and also the shear strength is preferably 0.05 MPa or more, more preferably from 0.05 to 0.3 MPa.

On the other hand, when the temporary fixing composition was used for the surface processing of the metals and the like, as described below, optimum properties are different. Specifically, the melt viscosity at 100° C. of the temporary fixing composition used for the surface processing of the metals and the like is from 1000 to 20000 mPa·s, preferably from 2000 to 20000 mPa·s, more preferably from 2000 to 150000 mPa·s. In addition, the Shore D hardness is from 20 to 50, preferably from 30 to 50. Further the Shore A hardness is preferably 80 or more, and also the shear strength is preferably 0.15 MPa or more, more preferably from 0.15 to 0.4 MPa.

The temporary fixing composition of the present invention has good handlability and workability in the surface processing, particularly in the flat surface polishing of the wafers and the like. The non-reactive temporary fixing composition has a tendency in which the ability to fix the wafers and the like is low, but the temporary fixing composition of the present invention has the high shear strength, and thus the wafers and the like can be sufficiently fixed during the polishing step. In addition, the temporary fixing composition of the present invention has the high hardness, and thus the temporary fixing composition cannot be deformed by the stress during the polishing step, and it can be said that the accuracy of the polishing is high.

### [Production of Temporary Fixing Composition Used for Grinding of Metal]

A temporary fixing composition used for the grinding of the metal was produced in the same manner as in the production of the temporary fixing composition used for the flat surface polishing of the wafers and the like. The preparation amounts are shown in detail in Table 4.

TABLE 4

| | | Ex- | Ex- | Ex- | Ex- | | | | | |
|---|---|---|---|---|---|---|---|---|---|---|
| | Starting | ample | ample | ample | ample | Comparative | Comparative | Comparative | Comparative | Comparative |
| Component | material | 21 | 22 | 23 | 24 | Example 20 | Example 21 | Example 22 | Example 23 | Example 24 |
| Component | X-C-7100 | 100 | 100 | 100 | 100 | 100 | 100 | 100 | 100 | 100 |
| (A) | X-C-4100 | | | | | | | | | |
| Component | I-MARVP- | 100 | 200 | 250 | 400 | 20 | 50 | 50 | 150 | 500 |
| (B) | 100 | | | | | | | | | |
| Component | Licocene | 20 | 100 | 25 | 50 | 10 | 10 | | | 50 |
| (C) | PP 1602 | | | | | | | | | |
| | PARAFFIN | | | | | | | | | |
| | WAX-155 | | | | | | | | | |
| | PARAFFIN | | | | | | | | | 100 |
| | WAX-130 | | | | | | | | | |
| | PARAFFIN | | | | | | | | | |
| | WAX-115 | | | | | | | | | |
| Others | IP | | | | | | | | | |
| | SOLVENT | | | | | | | | | |
| | 2835 | | | | | | | | | |

| | | | | | | | | | |
|---|---|---|---|---|---|---|---|---|---|
| Total | 220 | 400 | 375 | 550 | 130 | 160 | 150 | 250 | 750 |

### [Evaluation of Physical Property]

Physical properties of the temporary fixing compositions produced in Examples 21 to 24 and Comparative Examples 20 to 24 were evaluated.

### (Measurement of Melt Viscosity)

A melt viscosity was measured in the same manner as in the method used in the temporary fixing composition used for the flat surface polishing of the wafers and the like. The obtained results are shown in Table 5.

### (Measurement of Shore Hardness)

A Shore A hardness and a Shore D hardness were measured in the same manner as in the method used in the temporary fixing composition used for the flat surface polishing of the wafers and the like. The obtained results are shown in Table 5.

### (Measurement of Shear Strength)

A shear strength was measured in the same manner as in the method used in the temporary fixing composition used for the flat surface polishing of the wafers and the like, except that a stainless steel plate was coated with the temporary fixing composition. The obtained results are shown in Table 5.

TABLE 5

| | Example | Example | Example | Example | Comparative | Comparative | Comparative | Comparative | Comparative |
|---|---|---|---|---|---|---|---|---|---|
| Test Item | 21 | 22 | 23 | 24 | Example 20 | Example 21 | Example 22 | Example 23 | Example 24 |
| Melt viscosity | 2015 | 6000 | 6770 | 14180 | 733 | 816 | 689 | 2590 | 9000 |
| Shore A | 81 | Upper limit | 95 | Upper limit | Impossible | 80 | 80 | Upper limit | 94 |
| hardness | | value | | value | to measure | | | value | |
| Shore D | 32 | 47 | 32 | 34 | Impossible | 25 | 27 | 42 | 30 |
| hardness | | | | | to measure | | | | |
| Shear strength | 0.21 | 0.25 | 0.20 | 0.18 | 0.16 | 0.15 | 0.10 | 0.08 | 0.10 |

It was seen that in the case of the temporary fixation to the metals, optimum properties of the temporary fixing composition were different. Specifically, in the case of the temporary fixation of a glass plate, which corresponds to the wafers and the like, even the composition having a melt viscosity of less than 1000 mPa·s at 100° C. could be preferably used, but in the case of the temporary fixation of the metals, as apparent from the results of Table 5, when the melt viscosity was less than 1000 mPa·s at 100° C., the metal could not be firmly fixed. In addition, a tendency in which the shear strength was reduced in proportion to the reduction of the Shore D hardness was observed, and when the Shore D hardness was less than 30, it is possible to remove the temporary fixing composition from the metal. It can be thought that such results were obtained because of the difference in the specific gravity as one reason, thought clear reasons were not known.

### INDUSTRIAL APPLICABILITY

It is required to provide a high accuracy for the surface processing (polishing, grinding, and the like) of the wafers and the like and the metals with miniaturization and high performance of electronic parts. Improvement of production efficiency is also required. The present invention relates to the temporary fixing compositions satisfying these requirements, and can be used for the polishing of various wafers and the like or the grinding of metals.

### REFERENCE SIGNS LIST

Sings in FIG. 1 are as follows:
1: Head of a digital force gauge moving at a certain speed (a main body thereof is omitted.)
2: Glass plate temporarily fixed
3: Fixture

Sings in FIG. 2 and FIG. 3 are as follows:
1: Carrier
2: Temporary fixing composition
3: Wafer (Adherend)
4: Nozzle
5: Slurry
6: Pat conditioner
7: Platen
8: Pat

1. A temporary fixing composition used for flat surface polishing, which comprises the following components (A) to (C):
Component (A): a thermoplastic resin polymerized from an α-olefin having 16 to 35 carbon atoms alone;
Component (B): a hydrogenated tackifie r; and
Component (C): a hydrocarbon compound which is in the state of a solid at 25° C., and
having a melt viscosity of 1 to 5000 mPa·s at 100° C. and a Shore D hardness of 30 to 100.

2. A temporary fixing composition used for metal grinding, which comprises the following components (A) to (C):
Component (A): a thermoplastic resin polymerized from α-olefin having 16 to 35 carbon atoms alone;
Component (B): a hydrogenated tackifie r; and
Component (C): a hydrocarbon compound which is in the state of a solid at 25° C., and
having a melt viscosity of 1000 to 20000 mPa·s at 100° C. and a Shore D hardness of 20 to 50.

3. The temporary fixing composition according to claim 1, which does not substantially comprises a hydrocarbon compound which is in the state of liquid at 25° C.

4. The temporary fixing composition according to claim 1, wherein the component (B) is a hydrogenated copolymer of dicyclopentadiene and an aromatic compound.

5. The temporary fixing composition according to claim 1, wherein the component (B) is included in an amount of 100 to 600 parts by weight based on 100 parts by weight of the component (A).

6. The temporary fixing composition according to claim 1, wherein the component (C) includes a hydrocarbon compound having a softening point of 60 to 100° C. and a hydrocarbon compound having a melting point of 40 to 80° C.

7. The temporary fixing composition according to claim 1, wherein the component (C) is included in an amount of 1 to 600 parts by weight based on 100 parts by weight of the component (A).

8. The temporary fixing composition according to claim 2, which does not substantially comprises a hydrocarbon compound which is in the state of liquid at 25° C.

9. The temporary fixing composition according to claim 2, wherein the component (B) is a hydrogenated copolymer of dicyclopentadiene and an aromatic compound.

10. The temporary fixing composition according to claim 2, wherein the component (B) is included in an amount of 100 to 600 parts by weight based on 100 parts by weight of the component (A).

11. The temporary fixing composition according to claim 2, wherein the component (C) includes a hydrocarbon compound having a softening point of 60 to 100° C. and a hydrocarbon compound having a melting point of 40 to 80° C.

12. The temporary fixing composition according to claim 2, wherein the component (C) is included in an amount of 1 to 600 parts by weight based on 100 parts by weight of the component (A).
